(19) United States
(12) Patent Application Publication
(10) Pub. No.: US 2015/0147445 A1
(43) Pub. Date: May 28, 2015

(54) FOOD COMPOSITION AND METHOD

(71) Applicant: GENERAL MILLS, INC., Minneapolis, MN (US)

(72) Inventors: Peter Galuska, Hudson, WI (US); Eric T. Gugger, Rogers, MN (US); Christian E. Reiter, Minneapolis, MN (US)

(73) Assignee: GENERAL MILLS, INC., Minneapolis, MN (US)

(21) Appl. No.: 14/400,833

(22) PCT Filed: May 24, 2013
(86) PCT No.: PCT/US13/42562

§ 371 Date: Nov. 13, 2014

Related U.S. Application Data
(60) Provisional application No. 61/654,344, filed on Jun. 1, 2012.

(51) Int. Cl. A23L 1/16; A23L 1/0532; A23L 1/01

(52) U.S. Cl. CPC A23L 1/16; A23L 1/0142; A23L 1/0532; A23V 2002/00
USPC 426/276; 426/549; 426/557; 426/550

(57) ABSTRACT

A food composition or dough mixture and method. An alginate gel food composition or dough mixture is provided. In some embodiments, the composition includes water, alginate, and a polysaccharide textural modifier. In other embodiments, the composition further includes flour which may be present in reduced amounts compared to conventional dough-based food compositions. The composition is formed by mixing the components to form a dough mixture and contacting the dough mixture in a cation bath.

### TECHNICAL FIELD

The present invention relates to food compositions and method for making the food compositions; and more particularly to alginate gel food compositions having reduced caloric content, for example in the form of pasta or noodles, and food products which incorporate such food compositions.

### BACKGROUND OF THE INVENTION

Dough-based food composition and batters are used in the preparation of a large variety of food products, including baked or bakeable goods, cereals, cakes, cookies, breads, tortillas, pasta and other noodles, wrappers, and the like. In all such dough-based food compositions or products, including batters, as conventionally prepared, flour is typically amongst the main ingredients and often a major contributor to overall caloric content.

By way of illustration, pasta is traditionally made with wheat; usually a durum wheat flour or semolina (containing approximately 14 wt % moisture) is mixed with water to achieve a dough with a final moisture content of 30-32 wt %. This dough is then extruded into a desired form and dried. Other wheat flours may be used, such as hard red spring wheat, and eggs may be added in the case of noodles. Other types of noodles, such as the large variety of noodles consumed in many Asian countries and elsewhere, may also be made from wheat, buckwheat, rice, mung bean, sweet potato, corn starch, tapioca starch, potato starch, and konjac.

While varying by pasta type and degree of hydration, typical cooked pasta, spaghetti for example, would contain approximately 62 wt % moisture and 38 wt % wheat flour (38 wt % wheat flour on a dry solids basis, or equivalent to 44 wt % wheat flour at 14 wt % moisture) providing 158 kilocalories per 100 g (kcal/100 g) as consumed according to USDA, NDB No: 20421. At this level, wheat flour is one of the primary components of pasta noodles and is a major contributor to the overall caloric content of pasta or noodle containing food items.

There have been attempts to produce alternative food compositions that can be used in place of typical or conventional dough-based noodles and made using traditional pasta/noodle making techniques, i.e., traditional extrusion and drying. In such alternative food compositions, pasta or noodles have been prepared with a dough containing flour, such as wheat or rice flour and also an alginate. They are blended along with water, and other constituents, extruded and dried in the traditional manner. One example of such a food composition has about 98 parts of rice flour and about 2 parts of alginate compounds and is mixed with water to a total moisture content of about 30-45 wt %, extruded and dried. However, flour still remains a major or primary constituent of such alternate food compositions and the dough from which such food compositions are prepared is typically highly viscous, i.e., non-pourable.

Another alternative food composition that has been prepared is a gelled pasta product made of rice, wheat or other flour, an alginate compound, e.g. sodium alginate, and water. In an example of this food composition, the flour is about 99 wt % of the dry ingredients and alginate about 1 wt % and mixed with water to form a dough having about 45 to 50 wt % water and about 0.66 of sodium alginate. The dough is then extruded and drawn through a bath containing about 1% CaCl₂ to gel or solidify the extruded dough. However, as in the previously mentioned alternative food composition, this one also has flour as a major component and contributor to the overall caloric content of the resulting food composition.

It would be desirable to provide a food product or dough-based type food product that can be prepared from a food composition or dough mixture having a reduced flour content, e.g., of less than 38 wt % (dry basis) as consumed. Further, it would be desirable to provide a food product or dough-based type food product that can be prepared from a food composition that has a significantly reduced flour content and reduced caloric content compared to a conventional dough-based food product. It would also be desirable for some applications to provide a dough-based type food product that is prepared from a food composition that has no flour content or very little flour content for use in gluten-free or low gluten content food products. It would also be desirable to provide dough-based type food products, e.g., pasta or noodle and wrappers having a caloric content of less than 158 kcal/100 grams as consumed.

### SUMMARY OF THE INVENTION

A food composition, in accordance with an embodiment of the invention, includes a cross-linked alginate gel composed of a mixture of a flour, an alginate, a polysaccharide textural modifier, and water. In a non-limiting exemplary embodiment, the flour in the food composition is one of rice flour, wheat flour, soy flour, potato flour, corn flour, oat flour, barley flour, grain flour, starch, resistant starch, legume powders, and one or more vegetables and/or fruits. In certain embodiments, the one or more vegetables and/or fruits may be added directly to the mixture, whole or in pieces, and ground during processing. In alternate embodiments, the vegetables and/or fruits may be added in the form of a puree. Whether added as a puree or whole or pieces, the solids in the fruit or vegetables can serve as the flour in some embodiments. The textural modifier, in a non-limiting exemplary embodiment of the food composition is one of konjac glucomannan, guar gum, hydroxypropylmethycellulose, methycellulose, carrageenan, and xantham gum.

A method of preparing a food composition having an alginate gel, in accordance with an embodiment of the invention, includes mixing a flour, an alginate, a polysaccharide textural modifier and water to form a dough mixture. The dough mixture is extruded into a divalent cation salt bath of calcium and/or magnesium cations to form the food composition, which food composition is then removed from the cation bath. The food composition, after removal from the cation bath, is subjected to one or more of the following: rinsed and/or soaked to remove excess divalent cation salt, frozen, dried, stored, packaged, acidified, and/or cooked in water.

In a non-limiting exemplary embodiment of the food composition, the amount of flour is between about 0 wt % and about 40 wt %, the amount of alginate is between about 0.5 wt % and about 4 wt %, the amount of polysaccharide textural modifier is between about 0.5 wt % and about 4 wt %, and the amount of water is between about 57 wt % to about 99 wt %.

### BRIEF DESCRIPTION OF THE DRAWINGS

FIG. 1 is a table presenting compositional and comparative data on examples of food compositions according to embodiments of the invention and typical pasta dough and typical cooked pasta.

### DETAILED DESCRIPTION

The following detailed description is exemplary in nature and is not intended to limit the scope, applicability, composition or configuration of the invention in any way. Rather, the following description provides practical illustrations for implementing exemplary embodiments of the present invention.

Embodiments of the invention provide novel food compositions, dough mixtures, and methods of making the food compositions.

The formulation of the food compositions, dough mixtures and the associated methods of making allow for the production of dough-based type food products having a wide variety of shapes, ranging from the simple to the complex. Examples of the variety of types and shapes that can be prepared with food compositions or dough mixtures according to some embodiments of the invention include, but are not limited to, long noodles (e.g., Bucatini, Fuscilli, Soba, Udon), ribbon-cut noodles (e.g., spaghetti, linguine, and fettuccine, and Shahe fen), curvy noodles (e.g., Rotini), short-cut extruded noodles (e.g., Cannelloni, Macaroni, and Penne), spaetzle, decorative shaped (e.g., Rotelle), minute pasta and pasta sheets. The shape of food compositions according to the invention is not limited to pasta or noodle shapes. In fact, the food composition can be extruded and cut into shapes ranging from couscous to grains of rice to sheets or sheet-like food products such as tortillas, and egg roll and dumpling wrappers (such as may be used in preparation of gyoza or wonton) and the like. Products such as dumplings in the form of balls or pieces of “cooked” dough can also be prepared with the food compositions and method according to some embodiments of the invention. Additionally, with the use of fruit or vegetable purees in other embodiments, chewable food products or fruit snack products can also be prepared.

Food compositions or dough mixtures according to some embodiments can be prepared with reduced amounts of flour compared to food products prepared from conventional dough-based food products or, in some instance without any flour, and still have the structural integrity to provide a food product with complex shapes that are held or retained during and after the process of their preparation. Additionally, food compositions and dough mixtures according to some embodiments of the invention prepared with reduced amounts of or no flour will have a reduced caloric content on an as consumed basis compared to conventional dough-based food products having a greater flour content.

Applicants have found that they can prepare food compositions and dough mixtures according to the invention comprised of alginate, a polysaccharide textural modifier and water or comprised of alginate, a polysaccharide textural modifier, flour and water. As discussed in greater detail below, the food composition of the invention are formed by mixing the components to form a dough mixture that is contacted with a cation bath, specifically a divalent cation, with attendant gelation or crosslinking of the composition. It is a combination of the constituents and gelation of alginate that imparts the structural integrity needed to form food compositions according to the invention having complex shapes. Prior to contact with a cation bath and depending upon the formulation, dough mixtures according to embodiments of the invention may be prepared with a range of viscosities, e.g., have the consistency of a kneadable conventional dough, such as may be used for biscuits or rolls or it can be pourable such as in a pancake batter.

Alginate is a polysaccharide typically derived from the cell walls of brown algae and is commercially available in powder form. Alginate is available in various useful forms, including but not limited to sodium alginate and potassium alginate. Examples of commercially available alginates are Protanal® brand alginates available from FMC Biopolymers, Philadelphia, Pa., e.g., Protanal® SF 120RB, and TICA Algin® brand alginates available from TIC Gums, 4609 Richlynn Dr., Belcamp, Md. 21017, e.g., TICA Algin 400 powder.

While alginate itself is a polysaccharide, food compositions according to embodiments of the invention include both alginate and at least one non-alginate polysaccharide, referred to as “polysaccharide textural modifiers” or simply “textural modifiers.” Non-limiting examples of useful textural modifiers include but are not limited to konjac glucomannan, guar gum, hydroxypropylmethy-cellulose (HPMC), methycellulose, carrageenan, and xanthan gum. In some embodiments, the textural modifier is konjac glucomannan or konjac glucomannan powder, available, for example, as Nutricol® GP 312 Konjac Flour from FMC Biopolymers, Philadelphia, Pa. and KALYS Konjac Flour from KALYS SA: Z.A. la B\hat{t}ie, 30 Allée de Champrond, 38330 St-Ismier France. Guar gum examples include GRINDSTED® Guar from Danisco 201 New Century Parkway, New Century, Kans. 66031.

Flour derived from various sources, not just wheat flour, can be used in embodiments of the invention and is not limited to flour typically prepared from grains. Examples of the variety of flour that can be used includes but is not limited to rice flour, wheat flour, soy flour, potato flour, corn flour, oat flour, barley flour, grain flour, starch, and resistant starch, as well as, legume, vegetable or fruit powders or solids and combinations thereof. Thus, as the term “flour” is used herein, it should be understood to include grain and non-grain flours and powders and solids. Such solids may be provided in the form of purees, pastes or concentrates, e.g., fruit or vegetable purees; and in some embodiments of the invention, the flour may be provide only in the form of the solids in a puree or in conjunction with other flours in powder form. There term “puree” as used herein is intended to include pastes and concentrates formed of fruit or vegetables. In some embodiments of the method of the invention, the puree or solids are provide in the form of solid pieces of or whole fruit or vegetables that are pureed during the process of mixing or blending of the various components of the food composition. The fruit and vegetables may be cooked as appropriate prior to mixing and blending with the other ingredients. Examples of commercially available flour include Polar Bear Bleached Enriched Wheat Flour from ADM Milling, 1200 South Mill Road, Arkansas City Kans., and Rice Flour RL-100 from RivLand Partnership, Jonesboro, Ark.

Food compositions according to some embodiments of the invention may further contain various additives, such as flavorants and/or colorants. The additives may be provided in different forms, including powders, seasonings, ground food particulates, purees, liquids, oils, or mixtures such as slurries or suspensions. Vegetable powders, e.g., spinach or tomato, which may serve as flour in some embodiments may also be used as additives to provide color as well as nutritional properties and/or flavor in other embodiments. Vegetable, fruit or other purees may also be used to provide color, nutritional properties, and/or flavor in other embodiments. Color additives such as titanium dioxide, calcium carbonate, annatto, and paprika oil, to name a few, may be included to modify appearance.

Traditional cooked pasta noodles are made from a dough generally formed of water and wheat flour. While there are variations in their composition, typical cooked pasta noodles have a caloric content of about 158 kcal/100 grams as consumed and contain approximately 62 weight percent (wt %) moisture and about 38 wt % wheat flour (dry basis). Food compositions according to some embodiments of the invention can be prepared with comparable caloric content; and food compositions according to some other embodiments of the invention can be prepared with lower or reduced caloric content by utilizing a lower flour content than in typical pasta dough or flour-based dough compositions.

A reduction in flour content below 44% wt % (38 wt % dry basis) can provide an attendant reduction in caloric content. In some embodiments of the invention, the composition has a flour content below 44 wt % and can have a caloric content of less than 158 kcal/100 grams as consumed and in others of less than 120 kcal/100 grams. Thus, in yet other embodiments, the food composition can be prepared with different as consumed caloric content ranging from about 3 kcal/100 grams to about 158 kcal/100 grams or any range or value there between, e.g., from about 3 kcal/100 grams to about 120 kcal/100 grams, from about 3 kcal/100 grams to about 100 kcal/100 grams, or from about 3 kcal/100 grams to about 70 kcal/100 grams.

Such as consumed caloric content can be obtained in some embodiments of the invention with reduced flour content below 44 wt % based upon percent of total weight. Depending upon the desired caloric content to be achieved in food compositions according to the invention, the amount of flour present can range from about 0 wt % to about 40 wt %. However, simply reducing the amount of flour to such ranges alone or in conjunction with increasing the water content will not provide a suitable product without the addition of a functional equivalent that can impart the necessary structural strength needed to allow food compositions or doughs to be extruded or otherwise formed into and retain the variety of types and shapes, particularly complex shapes, of certain noodles or pasta.

In order to provide the structural integrity needed for extrusion of shaped food compositions, alginate with its high water absorption and gelling ability is used in amounts ranging from about 0.5 wt % to about 4 wt % to replicate the properties provided by the higher flour content of traditional flour-based noodle formulations. The gelation or crosslinking of the alginate in food compositions of the invention when contacted with a divalent cation bath allows the food compositions to retain the shape imparted by extrusion from a die. Gelation provides food compositions of the invention with a gel or crosslinked structure that is thermally stable and that retains the shape imparted by die extrusion.

Textural modifiers, such as konjac, can also contribute to improved final product texture, increased viscosity during processing, and are used generally in embodiments of the invention in amounts ranging from about 0.5 wt % to about 4 wt %.

Food compositions according to the invention may be referred to as alginate gel compositions, crosslinked alginate gel composition or divalent cation, crosslinked alginate gel compositions. The crosslinking occurs when food compositions according to embodiments of the inventions are contacted with a divalent cation bath, by immersion in, direct extrusion into, or being sprayed with a divalent cation bath, such as a calcium bath or a magnesium bath. A calcium bath can be prepared using a variety of calcium salts disassociated into water solutions, including but not limited to acetate, carbonate, chloride, glubionate, gluceptate, gluconate, lactate, lactobionate, and phosphate salts, or other salts that are useful as calcium replenishers and supplements. A magnesium bath can similarly be prepared using a variety of magnesium salts dissociated in water, including but not limited to chloride, acetate, citrate, and lactate salts.

When the divalent cation of the cation bath is calcium, the food composition may be referred to as a calcium crosslinked alginate gel composition. Similarly, when the divalent cation of the cation bath is magnesium, the food composition may be referred to as a magnesium crosslinked alginate gel composition.

Depending upon the desired texture, appearance or shape, or nutritional properties, the amount of the dry ingredients can be varied within their respective ranges in food compositions according to embodiments of the invention. Further, they may also be varied depending upon the desired caloric content to be achieved in the food. As previously mentioned, the amount of flour present can range from about 0 wt % to about 40 wt % and or any range or value within this broad range, e.g., from about 0 wt % to about 20 wt %, or from about 0 wt. % to about 15 wt % or from about 0 wt % to about 10 wt % or from about 0 wt % to about 5 wt % or about 2 wt % to about 20 wt %. Also as mentioned, the amount of each of alginate and the textural modifiers can range from about 0.5 wt % to about 4 wt % or any range or value there between. In compositions according to the invention, water in turn would make up an amount ranging from about 57 wt % to about 99 wt % of the food composition or dough mixture.

According to some embodiments of the invention, methods of preparing an alginate gel food composition is provided. In its various embodiments, the method generally includes the steps of mixing of the dry ingredients (flour, alginate, a polysaccharide textural modifier), in various combinations, and water to form a dough mixture, extruding the dough mixture into a divalent cation salt bath to form the food composition and removing the food composition from the cation bath. The mixing of the constituents that make up the dough mixture can be accomplished in various sequences, including but not limited to blending the dry ingredients and then mixing the dry blend with water or mixing the dry ingredients separately or in different combinations with water and then blending the mixture streams together.

While the dough mixture or food composition is in contact with the cation bath, the alginate gels or continues to gelatinize to provide the needed structure to retain a desired shape. After a suitable period of time, the resulting food composition is removed from the cation bath for further handling and/or processing. The further handling and/or processing can include, without regard to sequence, one or more of the following steps: cooking the extruded food composition in water after removal from the cation bath, rinsing and/or soaking the extruded food composition to remove excess divalent cation salt; freezing the extruded food composition; drying the extruded food composition, storing the extruded food composition, packaging the food composition, and acidifying the extrude food composition.

A cutting step may be included in some embodiments of the invention. For example, the extruded food composition may be cut as it is coming out of an extrusion die and before entering or being sprayed with the cation bath, cut in the bath with submerged extrusion directly in the bath (“underwater”), or the food composition may be cut to the desired length or dimensions after removal from the cation bath. Cutting directly from the extruder face may be accomplished, for example, by using a rotating cutting blade, while cutting the product following solidification in the cation bath may be accomplished, for example, by means of a rotary drum cutter. Other cutting devices known to be suitable to those skilled in the art may also be used.

In some embodiments of the invention, the method may include the optional step of allowing the dough mixture to hydrate prior to the extruding step, which can be beneficial to gelation and formation of the alginate structure within the food composition. In some other embodiments, the method may further include the step of heating the hydrated dough mixture to a temperature of at least 70° C. or of greater than 70° C. or >70° C. or of at least 95° C. Heating the hydrated mixture can also further benefit the overall process by thickening the dough mixture prior to extrusion and can impart different eating texture, i.e., mouthfeel, or organoleptic properties.

The packaging step may including mixing the extruded food composition with other food ingredients, such as vegetables, sauces, prepared meat, and the like, for packaged meals that may be ready to eat or that may require heating or cooking prior to consumption. Where the food composition is packaged alone, e.g., as packaged noodles, they may be cooked in water, for example at temperatures of at least 95° C. Cooking can be carried out for a suitable time period to heat the food composition as desired, e.g., for a period of 1-5 minutes. It should be understood that cooking can be in heated or boiling water or microwave oven or conventional oven, depending upon what dish or meal is being prepared with the food composition. Thus, food compositions according to some embodiments of the invention can be used much as tradition noodles or pasta.

As mentioned, acidification is another step that may be utilized in making a food composition according to some embodiments of the invention. In such embodiments, extruded food compositions can be immersed in a heated or unheated acid bath for a period of time after removal from the cation bath or the pH of the cation bath could be adjusted to the desired pH prior to removal. The acid bath would contain an amount of a food grade acid sufficient to achieve a pH of less than 4.5. In some applications, the pH of the acid bath is at or is adjusted to a pH ranging from about 3.0 to about 4.5 and in others the pH may range is at or is adjusted to a pH ranging from about 3.0 to about 4.2 or from about 3.8 to about 4.2. After being immersed for a prescribed period of time, e.g., of 1 to 30 minutes, the extruded food product can be packaged in a container, e.g., a tray or pouch, sealed with or without vacuum. The packaged food product can then be subjected to further thermal processing for a period of time. Acidification, alone or in conjunction with heating, helps provide a food product that is shelf stable at temperatures ranging from ambient or room temperatures to refrigerated temperatures. Non-limiting examples of suitable food grade acids include but are not limited to lactic acid, gluconic, malic, citric, and acetic acid. One specific example of a food grade lactic acid is Purac FCC lactic acid from Purac America, Lincolnshire, Ill. 60069.

The invention in some of its various embodiments can be further understood with reference to the below the examples.

### Example 1

A food composition according to an embodiment of the invention was prepared by dry blending 12.5 wt % of a hard red spring wheat flour (from ADM Milling), 1.5 wt % Protanal® SF 120RB alginate (from FMC Biopolymers), and 2 wt % Nutricol® GP 312 konjac (from FMC Biopolymers). The dry blend was mixed with 84 wt % water in a vessel with a high sheer mixer, a hand blender from KitchenAid, for 1 minute. The resulting dough mixture was allowed to sit and continue hydrating for 30 minutes. The pourable mixture was heated to a temperature of at least 95° C. for 2 minutes to further thicken the mixture prior to extrusion. The mixture was pourable and had a viscosity similar to a pancake batter. A divalent cation bath was prepared with 2 wt % calcium chloride in water. The cation bath was at a temperature of 20° C. The hydrated mixture was extruded into the cation bath through a brass rotini die connected to a plastic hose, with pressure applied to the dough mixture by means of a piston style sausage stuffer. The extruded mixture was allowed to remain in the cation bath for 30-40 minutes to allow further gelling of the food composition in the form of curly rotini pasta noodles to progress. The pasta noodles were removed from the cation bath, drained and then soaked in water for 30 minutes to remove excess calcium ions. The prepared food composition of this example was calculated to have a caloric content of 56.72 kcal/100 grams.

### Example 2

A food composition according to an embodiment of the invention was prepared by dry blending 1 wt % Protanal® SF 120RB alginate (from FMC Biopolymers), and 2 wt % Nutricol® GP 312 konjac (from FMC Biopolymers). The dry blend was mixed with 97 wt % water in a vessel with the high sheer mixer of Example 1 for 1 minute. The resulting dough mixture was allowed to sit and hydrate for 30 minutes. A divalent cation bath was prepared with 1 wt % calcium chloride in water. The cation bath was at a temperature of 20° C. The hydrated mixture was extruded into the cation bath through a brass spaghetti die connected to a plastic hose, with pressure applied to the dough mixture by means of a piston style sausage stuffer. The extruded mixture was allowed to remain in the cation bath for 30-40 minutes to allow further gelling of the food composition in the form of pasta noodles to progress. The pasta noodles were removed from the cation bath, drained and then soaked in room temperature water for 30 minutes to remove excess calcium ions. The prepared food composition of this example was calculated to have a caloric content of 10.24 kcal/100 grams.

### Example 3

A food composition according to an embodiment of the invention was prepared by dry blending 40 wt % of a hard red spring wheat flour, 0.5 wt % Protanal® SF 120RB alginate (from FMC Biopolymers), and 0.5 wt % Nutricol® GP 312 konjac (from FMC Biopolymers). The dry blend was mixed with 59 wt % water in a vessel with a Waring commercial blender for 1 minute to form a pourable dough mixture. The mixture was heated to a temperature of at least 95° C. for 2 minutes to further thicken the mixture prior to extrusion. The dough mixture was allowed to cool to room temperature prior to extrusion to form a more highly viscous mixture. A divalent cation bath was prepared with 2 wt % calcium chloride in water. The cation bath was at a temperature of 20° C. The hydrated mixture was extruded into the cation bath through a brass spaghetti die connected to a plastic hose, with pressure applied to the dough mixture by means of a piston style sausage stuffer. The extruded mixture was allowed to remain in the cation bath for 30-40 minutes to allow further gelling of the food composition in the form of pasta noodles to progress. The pasta noodles were removed from the cation bath, drained, soaked for 30 minutes in room temperature water to remove excess calcium, and then heated or cooked in water for 5 minutes at >95° C. During the process of draining and cooking the pasta noodles, excess calcium cations were removed. The prepared food composition of this example was calculated to have caloric content of 146.91 kcal/100 grams.

### Example 4

A food composition according to an embodiment of the invention was prepared by dry blending 12.5 wt % of Rice Flour RL-100 (from RivLand Partnership), 1.75 wt % Protanal® SF 120RB alginate (from FMC Biopolymers), and 2% Nutricol® GP 312 konjac (from FMC Biopolymers). The dry blend was mixed with 83.75 wt % water in a vessel using a Waring commercial blender as the high sheer mixer for 1 minute to form the dough mixture. The mixture was heated to a temperature of at least 95° C. for 5 minutes to further thicken the mixture prior to extrusion. The heated dough mixture was allowed to cool to room temperature prior to extrusion to form a more highly viscous mixture. A divalent cation bath was prepared with 2 wt % calcium chloride in water. The cation bath was at a temperature of 20° C. The hydrated mixture was extruded into the cation bath from a brass rice die fixed to the end of a plastic hose, with pressure applied to the dough mixture by means of a piston style sausage stuffer. The extruded mixture was allowed to remain in the cation bath for 30-40 minutes to allow further gelling of the food composition in the form of rice to progress. The rice was removed from the cation bath, drained and allowed to soak in room temperature water for 30 minutes to remove excess calcium ions. The prepared food composition of this exampled was calculated to have a caloric content of 57.51 kcal/100 grams.

### Example 5

A food composition according to an embodiment of the invention was prepared by first making a dry blend of 2 wt % air dried spinach powder (Van Drunen Farms), 1.75% Protanal SF120 sodium alginate (from FMC Biopolymers), 2 wt % Nutricol GP 312 konjac (from FMC Biopolymers) and 12.5 wt % hard winter wheat flour. Water was added in the amount of 81.75 wt % to the dry blend and mixed under high sheer and under vacuum in a Stephan mixer for approximately 1 minute to form a dough mixture. The mixture was extruded through a spaghetti die directly into a 1 liter calcium bath at room temperature containing 5 wt % calcium chloride in water to form pasta noodles. The extruded noodles were allowed to set in the calcium bath for a period of 20 minutes at room temperature. The noodles were then removed from the cation bath, drained and rinsed to remove excess calcium ions. The prepared food composition of this exampled was calculated to have a caloric content of 62.5 kcal/100 grams.

### Example 6

A food composition according to an embodiment of the invention was prepared by dry blending 1 wt % Protanal® SF 120RB alginate (from FMC Biopolymers), and 2% Nutricol® GP 312 konjac (from FMC Biopolymers). The dry blend was mixed with 52 wt % cooked carrot puree (made by boiling peeled and sliced fresh carrots for 10 minutes), and 45 wt % water in a vessel with the high sheer mixer of Example 4 for 1 minute to form a vegetable dough mixture. A divalent cation bath was prepared with 2 wt % calcium chloride in water. The cation bath was at a temperature of 20° C. The vegetable dough mixture was extruded into the cation bath from a brass spaghetti die fixed to the end of a plastic hose, with pressure applied to the dough mixture by means of a piston style sausage stuffer. The extruded mixture was allowed to remain in the cation bath for 30-40 minutes to allow further gelling of the food composition in the form of pasta noodles to progress. The pasta noodles were removed from the cation bath, drained and allowed to soak in room temperature water for 30 minutes to remove excess calcium ions. The prepared food composition of this exampled was calculated to have a caloric content of 28.44 kcal/100 grams.

### Example 7

A food composition according to an embodiment of the invention was prepared by dry blending 0.5 wt % Protanal® SF 120RB alginate (from FMC Biopolymers), and 0.5 Nutricol® GP 312 konjac (from FMC Biopolymers). The dry blend was mixed with 99 wt % water in a vessel with the high sheer mixer of Example 4 for 1 minute to form a dough mixture. A divalent cation bath was prepared with 2 wt % calcium chloride in water. The cation bath was at a temperature of 20° C. The hydrated mixture was extruded into the cation bath through a brass spaghetti die fixed to the end of a plastic hose, with pressure applied to the dough mixture by means of a piston style sausage stuffer. The extruded mixture was allowed to remain in the cation bath for 30-40 minutes to allow further gelatinization of the food composition in the form of spaghetti noodle to progress. The spaghetti noodles were removed from the cation bath, drained and allowed to soak in room temperature water for 30 minutes to remove excess calcium ions. The prepared food composition of this exampled was calculated to have a caloric content of 3.37 kcal/100 grams.

### Example 8

A food composition according to an embodiment of the invention was prepared by dry blending 10 wt % of a hard winter wheat flour (from ADM Milling), 1 wt % Protanal® SF 120RB alginate (from FMC Biopolymers), and 2 wt % Nutricol® GP 312 konjac (from FMC Biopolymers). The dry blend was mixed with 87 wt % water in a vessel with the high sheer mixer of Example 4 for 1 minute to form a dough mixture. A divalent cation bath was prepared with 5 wt % calcium chloride in water. The mixture was extruded into the cation bath from a spaghetti die fixed to the end of a plastic hose, with pressure applied to the dough mixture by means of a piston style sausage stuffer. The extruded mixture was allowed to remain in the bath for 20 minutes to allow further gelling of the food composition in the form of spaghetti noodles to progress. The noodles were removed from the cation bath, drained and rinsed. After rinsing, acidification was carried out by placing the noodles in an acid bath of 1 liter of water and adding lactic acid until a pH of 4.0 was reached and then maintained. The noodles were boiled for 5 minutes in the acid bath. The noodles were then cut or divided into 120 gram lots, vacuum sealed in polyethylene bags or pouches, and steam heated for a period of 5 minutes. Pouched noodles were kept refrigerated for two weeks for observation. Upon opening, there were no noticeable changes in texture or flavor, and compared to pouched commercial pasta products, the noodles in this example did not stick together and were easily removed from the pouch. The prepared food composition of this exampled was calculated to have a caloric content of 46.13 kcal/100 grams.

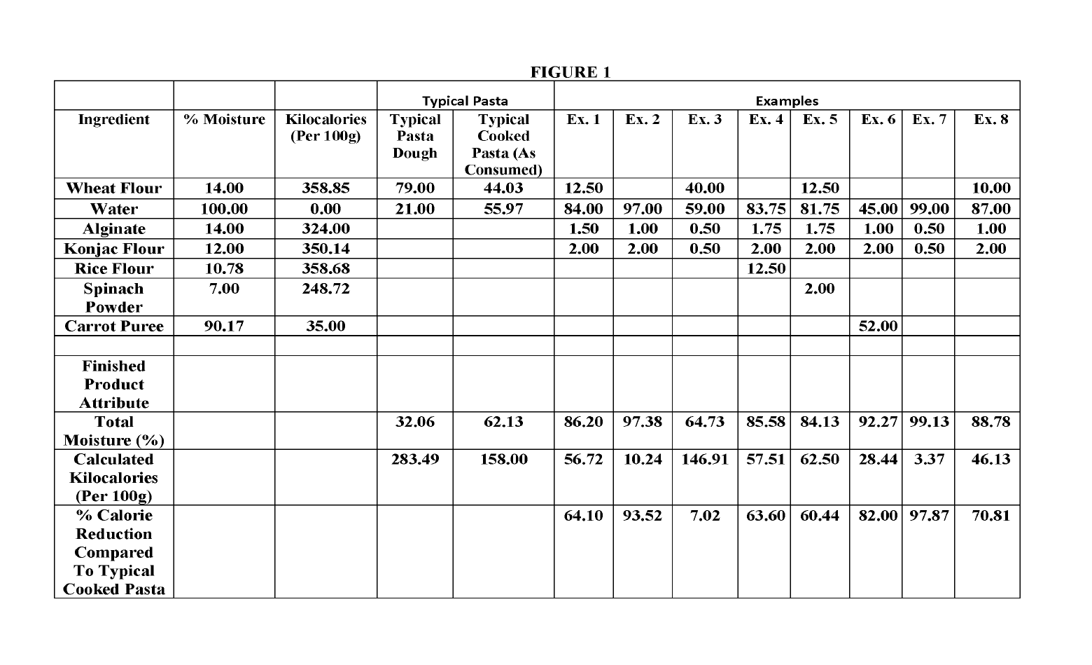

FIG. 1 is a table presenting compositional and comparative data on examples of food compositions according to embodiments of the invention and typical pasta dough and typical cooked pasta. The table includes both moisture and caloric content of the listed ingredients. Under the heading “Typical Pasta,” the composition and caloric content of both typical pasta dough and typical cooked pasta are presented as comparative examples. Regarding Examples 1-8, in addition to presenting wt % information and calculated caloric content for each example, the table provides the percent caloric reduction relative to the caloric content of typical cooked past as consumed. As can be readily seen, all of the examples had a calculated caloric content below the 158 kilocalories per 100 grams as consumed of a typical cooked pasta. The data shows that a food composition according to some embodiments of the invention can be prepared with significantly reduced caloric content.

While exemplary embodiments of this invention and methods of practicing the same have been illustrated and described, it should be understood that various changes, adaptations, and modifications may be made therein without departing from the spirit of the invention and the scope of the appended claims.

1. A food composition, comprising a cross-linked, alginate gel comprised of a flour, alginate, a polysaccharide textural modifier and water.

2. The food composition of claim 1, wherein the flour is present in an amount ranging from about 0 wt % to about 40 wt %, alginate is present in an amount ranging from about 0.5 wt % to about 4 wt %; polysaccharide textural modifier is present in an amount ranging from about 0.5 wt % to about 4 wt %, and water in an amount ranging from about 57 wt % to about 99 wt %.

3. The food composition of claim 1, wherein the textural modifier is selected from the group consisting of konjac glucomannan, guar gum, hydroxypropylmethycellulose, methycellulose, carrageenan, and xantham gum.

4. The food composition of claim 1, wherein the textural modifier comprises konjac.

5. The food composition of claim 1, wherein the food composition is in the form of pasta, noodles or rice and has a caloric content of less than 158 kcal/100 grams.

6. The food composition of claim 1, wherein the food composition has a caloric content of less than 120 kcal/100 grams.

7. The food composition of claim 1, wherein the food composition has a caloric content ranging from about 3 kcal/100 grams to about 120 kcal/100 grams.

8. The food composition of claim 1, wherein the flour is selected from the group consisting of rice flour, wheat flour, soy flour, potato flour, corn flour, oat flour, barley flour, grain flour, starch, resistant starch, legume powders, and vegetable powders.

9. The food composition of claim 1, further comprising a vegetable puree or a fruit puree.

10. The food composition of claim 1, wherein the flour is provided in the form of solids in ground cooked or uncooked pieces of or whole fruit or vegetables.

11. A food composition in the form of a noodle, the food composition comprising a calcium crosslinked alginate gel composition comprised of a flour present in an amount ranging from about 0 wt % to about 40 wt. %, alginate in an amount ranging from about 0.5 wt % to about 4 wt. %, konjac in an amount ranging from about 0.5 wt % to about 4 wt %, and water in an amount ranging from about 57 wt % to about 99 wt %, wherein the food composition has a caloric content ranging from about 3 kcal/100 grams to about 154 kcal/100 grams and the flour is a wheat flour.

12. A food composition, comprising a cross-linked, alginate gel comprised of an alginate, a polysaccharide textural modifier and water.

13. A method of preparing an alginate gel food composition, the method comprising the steps of:
mixing ingredients comprising a flour, an alginate, a polysaccharide textural modifier and water to form a dough mixture;
extruding the dough mixture into a divalent cation salt bath to form the food composition, wherein the divalent cation is a calcium and/or a magnesium cation; and
removing the food composition from the cation bath.

14. The method of claim 13, further comprising the step of:
cooking the extruded food composition in water after removal from the cation bath.

15. The method of claim 13, further comprising the step of:
allowing the dough mixture to hydrate prior to the extruding step.

16. The method of claim 13, following the mixing step and prior to the extruding step, further comprising the steps of:
allowing the dough mixture to hydrate; and
heating the hydrated dough mixture to a temperature of at least 70° C. to thicken the dough mixture.

17. The method of claim 13, further comprising, after the removal step, one or more of the following steps: rinsing the extruded food composition to remove excess divalent cation salt; soaking the extruded food composition to remove excess divalent cation salt; freezing the extruded food composition; drying the extruded food composition, storing the extruded food composition, packaging the food composition, and acidifying the extruded food composition.

18. The method of claim 13, further comprising the step of cooking the extruded food composition in water at a temperature of at least 95° C.

19. The method of claim 13, wherein the flour is present in an amount ranging from about 0 wt % to about 40 wt %, alginate is present in an amount ranging from about 0.5 wt % to about 4 wt %; polysaccharide textural modifier is present in an amount ranging from about 0.5 wt % to about 4 wt %, and water is present in an amount ranging from about 57 wt % to about 99 wt %.

20. The method of claim 18, wherein the extruded food composition is cooked in the cooking step for a period of 1-5 minutes.

21. The method of claim 13, wherein the extruded food composition has a caloric content of between about 3 to about 154 calories per 100 grams.

22. The method of claim 13, wherein during the extruding step, the dough mixture is extruded in the form of pasta, noodles or rice.

23. The method of claim 13, wherein the flour is selected from the group consisting of rice flour, wheat flour, soy flour, potato flour, corn flour, oat flour, barley flour, grain flour, starch, resistant starch, legume powders, and vegetable powders.

24. A method of preparing an alginate gel food composition, the method comprising the steps of:
mixing an alginate, a polysaccharide textural modifier and water to form a dough mixture;
extruding the dough mixture into a divalent cation salt bath to form the food composition, wherein the divalent cation is a calcium and/or a magnesium cation; and
removing the food composition from the cation bath
